(19) United States
(12) Patent Application Publication
(10) Pub. No.: US 2023/0409794 A1
(43) Pub. Date: Dec. 21, 2023

(54) A METHOD OF EVALUATING CIRCUIT PROTECTION OF A POWER NETWORK

(71) Applicants: University of Pretoria, Pretoria (ZA); University of Sharjah, Sharjah (AE)

(72) Inventors: Martin Slabbert, Christchurch (NZ); Raj Naidoo, Pretoria (ZA); Ramesh Bansal, Haridwar Uttarakhand (IN)

(73) Assignees: University of Pretoria, Pretoria (ZA); University of Sharjah, Sharjah (AE)

(21) Appl. No.: 18/035,103

(22) PCT Filed: Oct. 28, 2021
(86) PCT No.: PCT/IB2021/059982

§ 371 Date: May 2, 2023

(30) Foreign Application Priority Data
Nov. 3, 2020 (ZA) 2020/06849

(51) Int. Cl. G06F 30/367

(52) U.S. Cl. CPC G06F 30/367; G06F 2113/04

(57) ABSTRACT

This invention relates to a method (30) and system (10) for evaluating circuit protection of a power network. The method (30) includes simulating (32) a multisource, interconnected power network (40) comprising circuit protection elements (A, B, C, D), setting (33) circuit protection element parameters for each circuit protection element, simulating (35) at least one fault (42) on the power network (40) at a predetermined fault position for a predefined simulation time. In a next step, the method includes calculating (38) conductor LTE exposure and determining (39) an LTE threshold. Furthermore, the method (30) includes simultaneously graphically representing (41) a three-dimensional visualisation of the conductor LTE exposure (50) for the predefined simulation time and the LTE threshold (51), on the same three-dimensional visualisation. The method provides a wholistic approach for simulating and determining a dynamic effect of faults for chosen circuit protection settings on conductor LTE exposure compared to LTE thresholds.

### FIELD OF INVENTION

The invention relates generally to electrical power distribution networks and, more particularly, to a computer-implemented method and system for evaluating circuit protection of power distribution networks.

### BACKGROUND OF INVENTION

As current flows through a material such as an electrical conductor, the material heats up due to internal resistance of the material. Excessive heating of the material may result in annealing thereof which can alter and/or weaken the material. This alteration may take the form of elastic (i.e. self-reversing) or plastic (non-self-reversing) deformation. If an overhead conductor is exposed to excessive overcurrent conditions, the conductor will encroach upon a minimum clearance from the ground. Accordingly, the conductor may sag toward the ground. Normally, three conductors of a three-phase system will have a similar profile. If one conductor is exposed to a crosswind, all three conductors will swing or sway a similar distance, thus maintaining the phase clearance. However, if one phase conductor of the three-phase system was damaged, the damaged phase may swing more, and this can result in an increase in phase-to-phase and single phase to ground faults. The damaged conductor can stay in service, but in time the damaged conductor material may result in a failure. On an actual feeder, the whole conductor will carry the same current up to the fault point. This means that the entire conductor up to the fault point is subjected to the same damage. Accordingly, prolonged overcurrent exposure will damage a conductor. The purpose of circuit protection equipment, such as circuit breakers, is to interrupt or break fault current flowing in the conductor prior to it being damaged. The amount of energy let through by circuit protection elements, before tripping once a fault has occurred, is referred to as Let-Through Energy (LTE).

All conductors have internal resistance (R) associated with them. Power dissipated over a conductor is equal to the square of the current (I) passing through the conductor multiplied by the resistance of the conductor. For alternating current, a Root Mean Square (RMS) value will be used. If a time component is added to this power calculation, energy dissipated in the conductor can be calculated. Based on the aforementioned, one can write an equation (1.1) for energy dissipated in a resistor as follows:

Energy=I²Rt (1.1)

where Energy is the energy calculated in watt-hour, I is the fault current (A), R is resistance (ohm) and t is time (s).

As current passes through the conductor, heat is generated in the conductor based on the resistance of the conductor. The higher the current, the more heat will be generated. If an assumption is made that all the heat that is generated by the flow of current is contained within the conductor itself during a fault, i.e. an adiabatic process where no heat is lost to the environment due to convection or conduction etc., one can set the heat energy generated by flow of current equal to the heat energy gained by the conductor. For each type of conductor, a numerical value, also known as the LTE rating, threshold or limit, is associated with the amount of energy the conductor can dissipate before it is damaged. The LTE rating, threshold or limit (I²t-energy) for each conductor can therefore be determined.

This measure of the amount of energy the conductor can handle before getting damaged can also be stated as a short time rating which refers to the amount of current the conductor can carry for 1 second before it gets damaged. For example, a Mink conductor has a short time rating for 1 s of 5.4 kA which means it can carry 5400 A for 1 s.

Because the assumption of an adiabatic process is made, one can set the energy rating (I²t-energy) for one instance equal to the energy for another instance. This is show in equation (1.2).

I₁²t₁=I₂²t₂ (1.2)

t₂=(I₁/I₂)²t₁

Where I₁ is the fault current (A) for instance one, I₂ is the fault current (A) for instance two, t₁ is the fault current withstand time (s) for instance one and t₂ is the fault current withstand time (s) for instance two. By using equation (1.2), one can determine how long the Mink conductor can sustain a particular fault current before it gets damaged. As an example, if the Mink conductor is exposed to a fault current of 2500 A, it can sustain that current for 4.67 s before it gets damaged. If the fault current was equal to 8000 A, the conductor will be able to sustain this current for 0.456 s before it is damaged. If the Mink conductor is used and the withstand times are calculated over a range of fault currents, a damage curve can be created for the Mink conductor. Furthermore, when the LTE rating (I²t-energy) is calculated and superimposed on the same damage curve, it will result in a straight line instead of a curve due to it being a constant. As an example, the LTE rating for the Mink conductor will be equal to 29.16 MA² s (5400 A for 1 s).

Since the LTE rating is a constant, it serves as a better reference when evaluating circuit protection. In other words, it is easier to refer to the energy rating or LTE rating when assessing the adequacy of current conductor circuit protection due to it being constant instead of referring to the short time rating which varies with the fault current. This is illustrated in FIG. 1.1 where the short time rating and LTE rating for a conductor is shown over a current range.

FIG. 1.1. Let-through energy and short time damage curves for conductor (4500 A for 1 s).

Referring to FIG. 1.1, this conductor has a short time rating of 4500 A for 1 s. Both graphs illustrated in FIG. 1.1 are damage curves for this conductor. The one is expressed in terms of LTE energy and the other in terms of time at a specific current (short time rating). Let-Through Energy (LTE) protection refers to protective measures taken to prevent damage to feeders or conductors based upon an assessment of conductor Let-Through Energy exposure. To ensure a conductor is protected, LTE exposure should be less than the LTE rating, threshold or limit of the specific conductor. Two factors influence LTE exposure. These include the magnitude of the fault current and the fault clearing time, which depends upon the protection settings of the network. A network cannot be designed to be immune to faults. Hence, there is need for network protection. Protection philosophy dictates how faults on the network should be dealt with and how the network should perform when a fault occurs. Factors which make up a protection philosophy include speed, sensitivity, selectivity, reliability and security. Conventional circuit protection measures of radial and multisource networks are focused upon using optimisation techniques to determine required protection settings of the circuit protection elements. The electricity industry is changing constantly with a continuous reduction in cost of renewable energy generation. Traditional medium voltage networks are radial in nature and current protection philosophies applied to them are fit for radial networks. However, in interconnected networks, current can flow from both ends of a feeder or conductor. Accordingly, as electricity distribution networks evolve, protection philosophy will have to adapt so as to meet the change in network topology.

The present invention aims to alleviate the drawbacks discussed above.

### SUMMARY OF INVENTION

According to a first aspect of the invention, there is provided a computer-implemented method of evaluating circuit protection of a power network, the method including:
simulating, using a power network simulation module, a power network which includes at least one power source, at least one conductor or feeder connected to the power source and associated circuit protection;
simulating, using the power network simulation module, at least one fault on the power network at a predetermined fault position on the conductor or feeder for a predefined simulation time;
calculating, using a processor, conductor Let-Through Energy (LTE) exposure, due to the simulated fault, across a predetermined length of the conductor for the predefined simulation time; and
graphically representing, using a graphical display of a computing device, a three-dimensional visualisation of the conductor LTE exposure across the predetermined length of the conductor for the predefined simulation time.

The three-dimensional visualisation may have three axes. A first axis of the three-dimensional visualisation may represent line distance or position (in metres) along the predetermined length of the conductor. A second axis of the three-dimensional visualisation may represent elapsed fault time (in seconds). A third axis may represent LTE energy (MA² s).

Simulating a power network may include determining an LTE threshold or limit for the conductor or feeder of the power network.

Graphically representing the three-dimensional visualisation of the conductor LTE exposure may include simultaneously graphically representing the LTE threshold for the conductor and the conductor LTE exposure on the same three-dimensional visualisation.

The method may include highlighting intersection of the LTE threshold and the conductor LTE exposure on the three-dimensional visualisation. The method may include graphically representing, using the graphical display, a heatmap of the conductor LTE exposure including the highlighted intersection of the LTE threshold and the conductor LTE exposure which graphically illustrates a depth of damage caused along the conductor by excessive conductor LTE exposure over time.

The method may therefore include superimposing, in three dimensions, using the graphical display, the simulated conductor LTE exposure over the LTE threshold for the conductor in the three-dimensional visualisation.

Based upon the graphical representation of the three-dimensional visualisation, the method may include identifying, using the computing device, areas along the conductor where conductor LTE exposure exceeds the LTE threshold, if any. The method may include calculating, using the processor, a threshold-exceeding fault time which is the fault time at which the conductor LTE exposure exceeds the LTE threshold at any given point along the conductor.

Simulating a power network may include simulating, using the power network simulation module, multiple circuit protection elements at different positions of the power network. Simulating the power network may include setting circuit protection parameters for each circuit protection element based upon a specific protection philosophy. Simulating the power network may further include grading the network so as to obtain selectivity and ensuring that the circuit protection elements are sensitive to faults.

The method may therefore include suggesting, using the power network simulation module, potential changes to the simulated circuit protection parameters to prevent the LTE exposure from exceeding the LTE threshold.

Simulating the power network, using the power network simulation module, may include simulating a multi-source power network. Simulating the power network, using the power network simulation module may include simulating an interconnected power network.

Calculating conductor LTE exposure may include generating, using a data generation module, fault current values of the power network based upon the circuit protection of the power network for the predefined simulation time and at each position along the predetermined length of the conductor. Calculating conductor LTE exposure may include generating, using the processor, data capable of forming a three-dimensional visual representation.

Calculating conductor LTE exposure may include generating, using the data generation module, a matrix of discrete incremental data points for the predetermined length of the conductor and the predefined simulation time. The method may further include calculating, using the processor, conductor LTE exposure for each data point of the matrix.

The method may be performed on a multi-source, interconnected power network. Accordingly, the power network may be a multi-source interconnected power network.

The method may include calculating, using the processor, a volume under the three-dimensional visualisation of the conductor LTE exposure. The volume may be calculated by taking a product of line distance (in metres), fault time (in seconds) and LTE exposure (MA² s). The volume may be calculated based upon time and distance step sizes used to create a matrix of discrete data points for fault time and feeder length or distance in the simulation. The calculated volume aids in quantifying conductor LTE exposure into a single figure. This calculated volume figure may be used to assess the effect of changes made to circuit protection parameters upon conductor LTE exposure with the aim of classifying the net effect on the conductor LTE exposure as an increase, decrease or no effect. This aids in configuring the circuit protection parameters applied in the power network.

In accordance with another aspect of the invention, there is provided a system for evaluating circuit protection of a power network, the system including at least one computing device having a processor and a power network simulation module, wherein the system is configured to:
simulate, using the power network simulation module, a power network which includes at least one power source, at least one conductor or feeder connected to the power source and associated circuit protection;
simulate, using the power network simulation module, at least one fault on the power network at a predetermined fault position on the conductor or feeder for a predefined simulation time;
calculate, using the processor, conductor Let-Through Energy (LTE) exposure, due to the simulated fault, across a predetermined length of the conductor for the predefined simulation time; and
graphically represent, using a graphical display of the computing device, a three-dimensional visualisation of the conductor LTE exposure across the predetermined length of the conductor for the predefined simulation time.

The system may be configured to determine an LTE threshold or limit for the conductor or feeder of the power network.

The system may be configured simultaneously to graphically represent the LTE threshold for the conductor and the conductor LTE exposure on the same three-dimensional visualisation.

The computing device may therefore be configured to superimpose, in three dimensions, using the graphical display, the simulated conductor LTE exposure over the LTE threshold for the conductor in the three-dimensional visualisation. The system may be configured to identify, using the computing device, areas along the conductor where conductor LTE exposure exceeds the LTE threshold, if any. The system may be configured to calculate, using the processor, a threshold-exceeding fault time which is the fault time at which the conductor LTE exposure exceeds the LTE threshold at any given point along the conductor.

The system may be configured to set circuit protection parameters based upon a specific protection philosophy.

The simulated power network may include multiple circuit protection elements.

The computing device of the system for evaluating circuit protection of a power network may include program instructions stored in memory, which when executed by the processor of the computing device, enable it to carry out any of the method steps described above.

The system may be configured to calculate, using the processor, a volume under the three-dimensional visualisation of the conductor LTE exposure. The volume may be calculated by taking a product of line distance (in metres), fault time (in seconds) and LTE exposure (MA² s). The volume may be calculated based upon time and distance step sizes used to create a matrix of discrete data points for fault time and feeder length or distance in the simulation. The calculated volume aids in quantifying conductor LTE exposure into a single figure. This calculated volume figure may be used to assess the effect of changes made to circuit protection parameters upon conductor LTE exposure with the aim of classifying the net effect on the conductor LTE exposure as an increase, decrease or no effect. This aids in configuring the circuit protection parameters applied in the power network.

In accordance with yet another aspect of the invention, there is provided a computer program product comprising a computer readable storage medium having program instructions stored thereon which are executable by a computing system to enable the computing system to perform any of the method steps described above.

The invention extends to a non-transitory computer readable storage medium, having program instructions stored thereon, which, when executed by a processor of a computing system, enable the computing system to perform any of the method steps described above.

### BRIEF DESCRIPTION OF DRAWINGS

The invention will now be further described, by way of example, with reference to the accompanying schematic drawings.

In the drawings:

FIG. 1 shows a functional block diagram of a system for evaluating circuit protection of a power network in accordance with the invention;

FIG. 2 shows a flow diagram of a computer-implemented method of evaluating circuit protection of the power network in accordance with another aspect of the invention;

FIG. 3 shows a diagrammatic representation of a multisource feeder simulation concept of a power network;

FIG. 4 shows a schematic representation of a multisource, interconnected power network;

FIG. 5 shows a conceptual three-dimensional visualisation of conductor Let-Through Energy (LTE) exposure and a conductor LTE threshold across the conductor;

FIG. 6 shows an exemplary three-dimensional visualisation of the conductor LTE exposure across the conductor vs. a LTE limit or threshold for a predefined simulation time;

FIG. 7 shows another exemplary three-dimensional visualisation of the conductor LTE exposure across the conductor vs. the LTE threshold for a multi-source interconnected power network for a predetermined simulation time; and

FIG. 8 shows a two-dimensional representation of a heat map including highlighted intersections of conductor LTE exposure and the LTE threshold.

### DETAILED DESCRIPTION OF AN EXAMPLE EMBODIMENT

The following description of the invention is provided as an enabling teaching of the invention. Those skilled in the relevant art will recognise that many changes can be made to the embodiments described, while still attaining the beneficial results of the present invention. It will also be apparent that some of the desired benefits of the present invention can be attained by selecting some of the features of the present invention without utilising other features. Accordingly, those skilled in the art will recognise that modifications and adaptations to the present invention are possible and can even be desirable in certain circumstances, and are a part of the present invention. Thus, the following description is provided as illustrative of the principles of the present invention and not a limitation thereof.

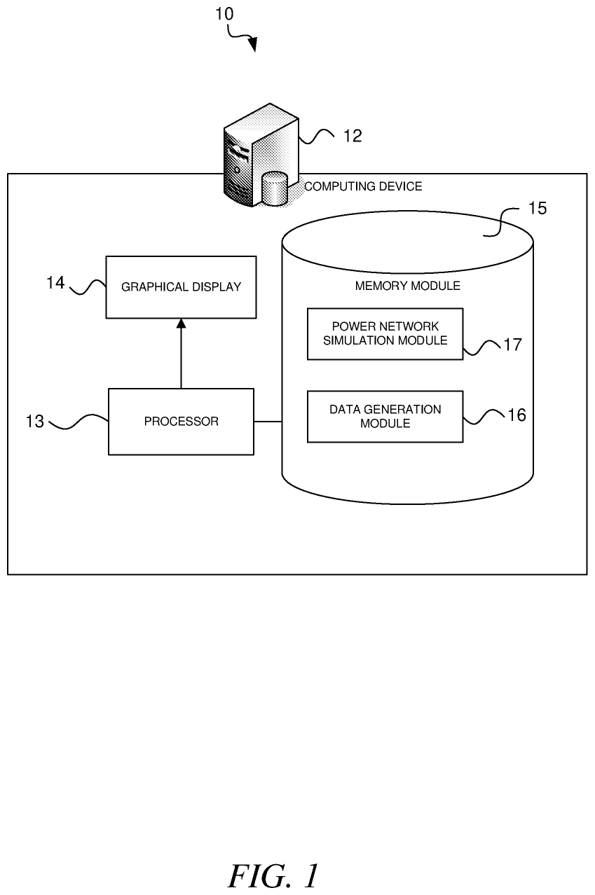

In FIG. 1, reference numeral 10 refers generally to a system for evaluating circuit protection of a power network in accordance with the invention. The system 10 includes a computing device 12 which includes a processor 13, a graphical display 14 communicatively linked to the processor 13 and configured to display two and three-dimensional graphical representations or visualisations and memory 15 having a power network simulation module 17 and a data generation module 16 stored thereon.

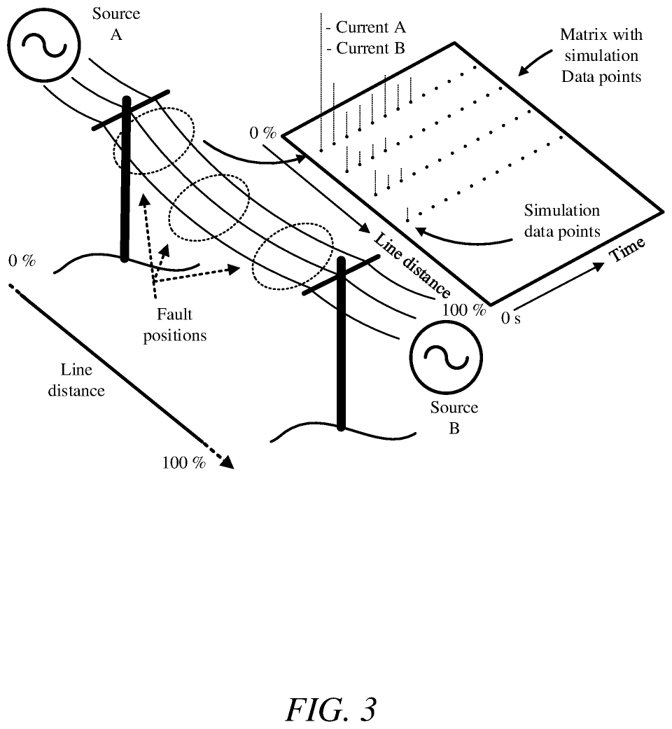

A conceptual multisource simulated power network is illustrated in FIG. 3. Each feeder has two points of supply, being Source A and then Source B. To isolate a fault the protection at both ends of the feeder must operate. For the purposes of illustration, the feeder may be divided into one hundred and one evaluation positions across a length of the feeder. This is based on an original one hundred points decided upon and then also one point for a fault level at 0% of the feeder distance. At each of these fault positions, a time simulation is done with a step size of 1 ms. At each distance and time step intersection a simulation data point is created using the data generation module 16. At these data points values of current such as the current from source A (Current A) and that of B (Current B) can be sampled. Other variables can be sampled as well, based on available variables in the power network simulation module 17. Resultant values at the various simulation data points are then written to an output file.

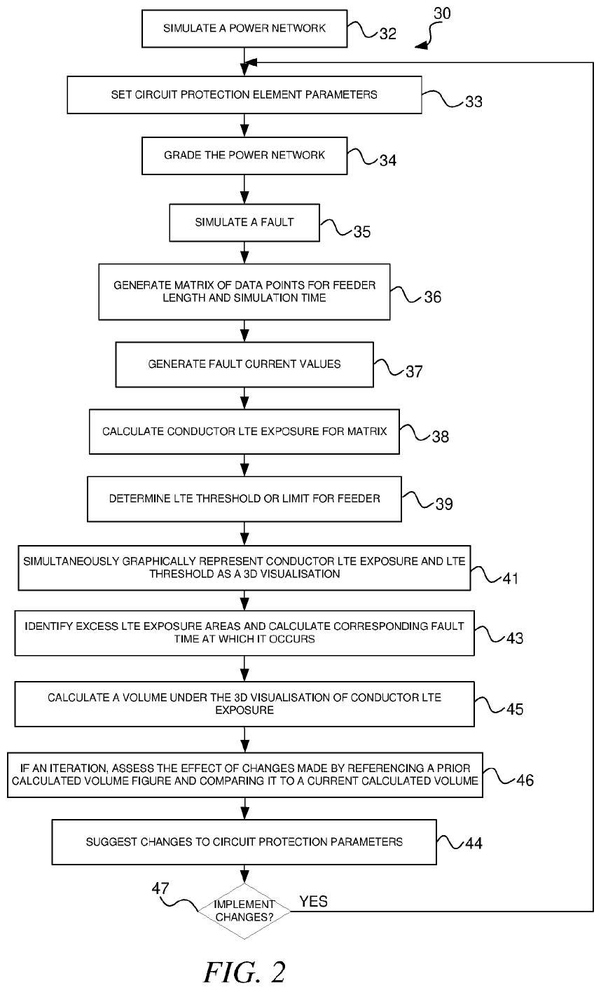

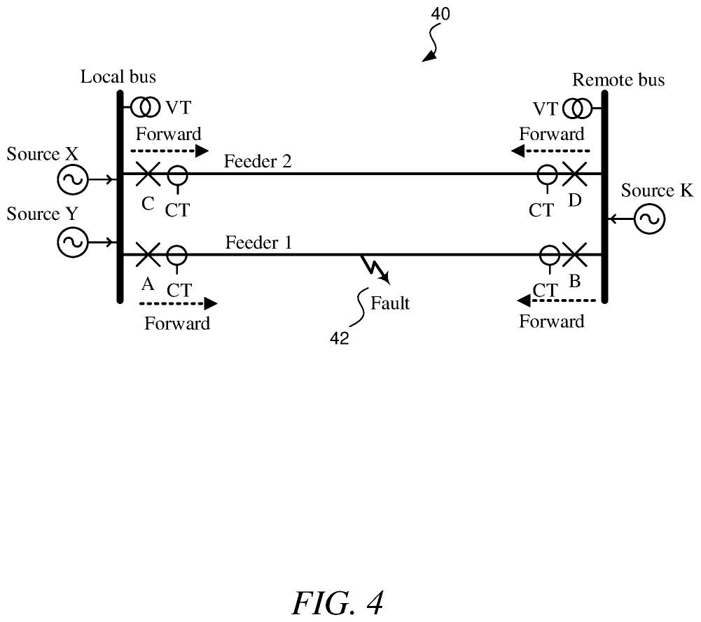

Reference is now made to FIG. 2 where reference numeral 30 indicates a computer-implemented method of evaluating circuit protection of the power network in accordance with a second aspect of the invention. The method 30 includes simulating 32, using the power network simulation module 17, a multisource, interconnected power network 40 as illustrated in FIG. 4 which includes multiple power sources (X, Y, K), two parallel conductors or feeders (Feeder 1, Feeder 2) connected between a local bus and a remote bus which are, in turn, connected to the power sources (X, Y, K) and associated circuit protection equipment comprising circuit protection elements (A, B, C, D), such as circuit breakers, arranged at opposing ends of the feeders. For an interconnected multisource network more than one circuit breaker has to operate to isolate the fault. The power source (X, Y, K) or generator can remove itself from the power network 40 by making use of protection if the fault is left on the network for long enough. Therefore, when a fault occurs, the current measured by the circuit protection elements or circuit breakers (A, B, C, D) varies. By modelling the circuit breakers or protection relays at the required places or positions of the network 40 under study, current redistribution network dynamics can be included or accounted for.

The method 30 further includes setting 33, using module 17, circuit protection element parameters for each circuit protection element (A, B, C, D) based upon a specific protection philosophy and grading 34, using module 17, the power network 40 so as to obtain selectivity and ensuring that the circuit protection elements (A, B, C, D) are sensitive to faults. The method 30 further includes simulating 35, using the power network simulation module 17, at least one fault 42 on the power network 40 at a predetermined fault position on feeder 1 for a predefined simulation time. More specifically, the method 30 includes generating 36, using the data generation module 16, a matrix of discrete incremental data points for the predetermined length of feeder 1 and the predefined simulation time. This method 30 further includes generating 37, using the data generation module 16, fault current values of feeder 1 based upon the circuit protection element parameters of the power network 40 for the predefined simulation time and at each position along the feeder 1.

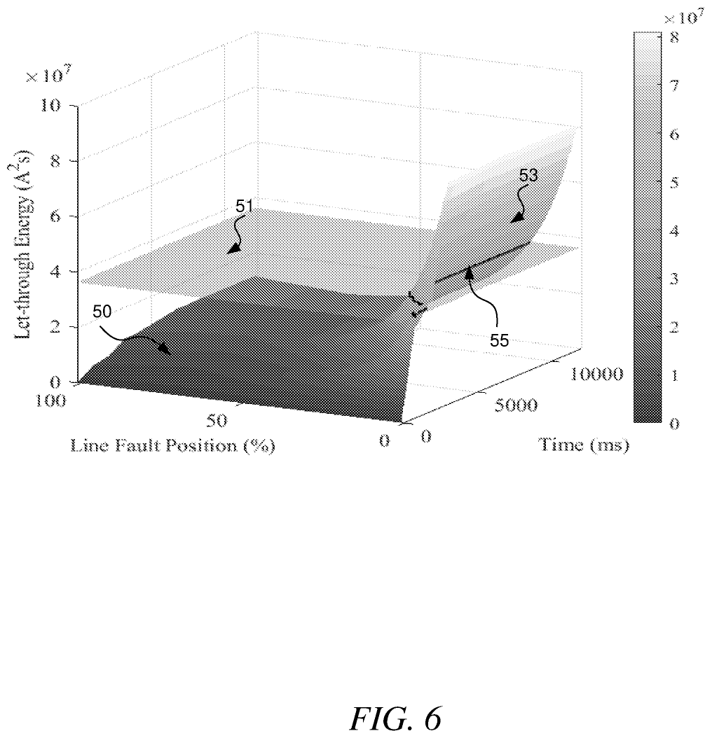

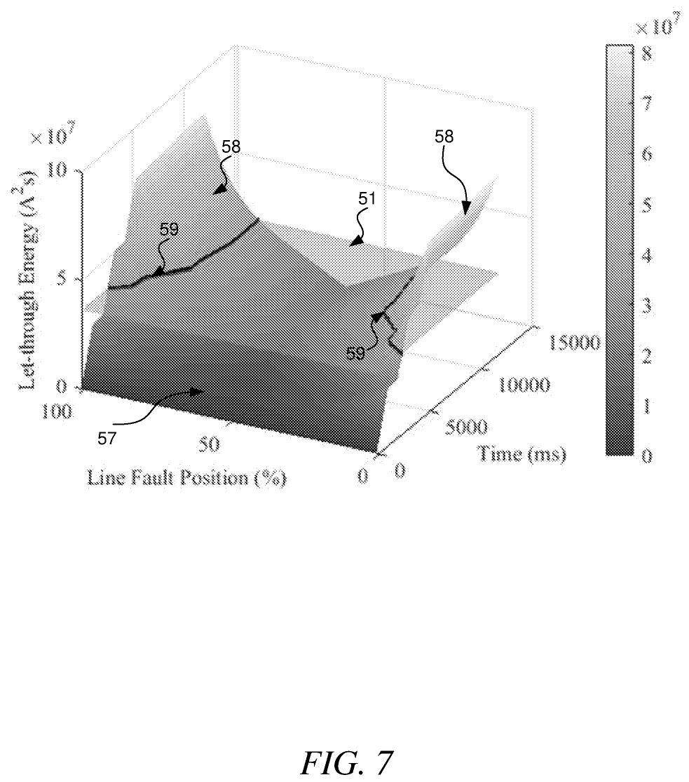

In the next step, the processor 13 calculates 38 conductor LTE exposure for each data point of the matrix. The method 30 further includes determining 39 an LTE threshold or limit for the feeders (Feeder 1, Feeder 2) of the power network 40. Furthermore, the method 30 includes simultaneously graphically representing 41, using the graphical display 14, a three-dimensional visualisation (see FIGS. 6 and 7) of the conductor LTE exposure 50, 57 across feeder 1 for the predefined simulation time and the LTE threshold 51 of feeder 1 on the same three-dimensional visualisation.

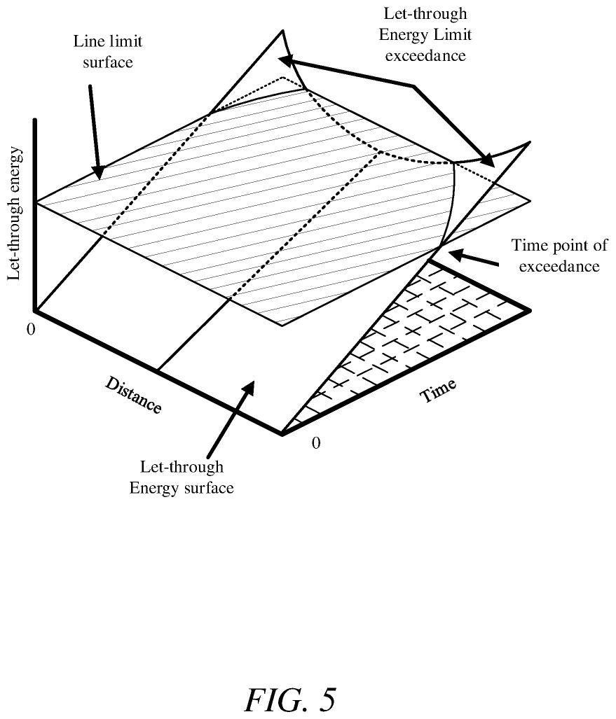

As can be seen in FIGS. 5, 6 and 7, the three-dimensional visualisation has a first axis representing line fault distance or position (in metres) along the conductor or feeder, a second axis of the three-dimensional visualisation represents elapsed fault time (in seconds) and a third vertical axis represents conductor LTE exposure (MA² s). FIG. 6 illustrates a first scenario where the power source(s) toward a 0% line fault position exceeds a power source at the opposing end of the feeder and accordingly, as can be deduced from the figure, conductor LTE exposure is more severe toward the 0% line fault position. FIG. 7, on the other hand, illustrates a second scenario where power sources on opposite ends of the feeder are more or less equal. Accordingly, with auto-reclose functionality built into the circuit protection, both ends of the feeder are subjected to conductor LTE exposure levels which exceed the LTE threshold 51 of the feeder.

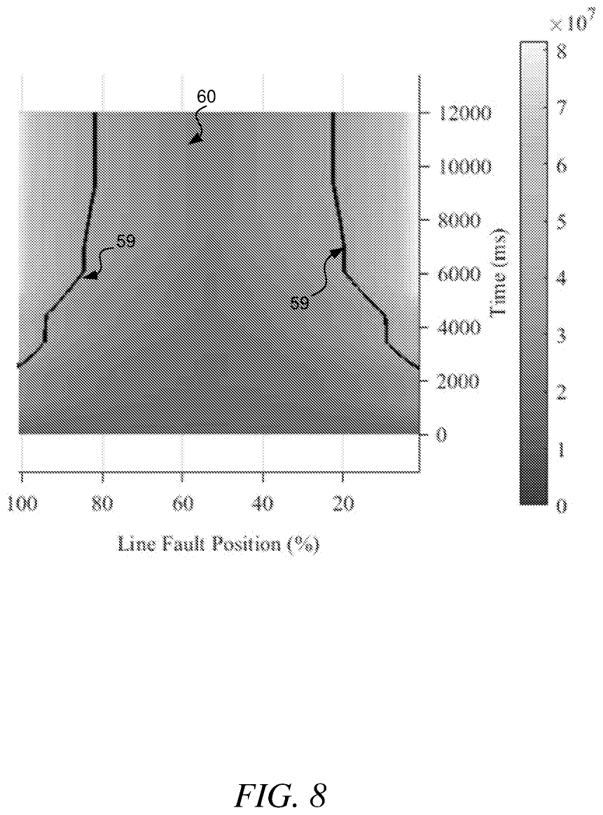

Based upon the graphical representation of the three-dimensional visualisation, the method 30 may include identifying 43, using the processor 13 of the computing device 12, areas 53, 58 along the feeder where conductor LTE exposure 50, 57 exceeds the LTE threshold 51, if any. The method 30 may include calculating, using the processor, a threshold-exceeding fault time which is the fault time at which the conductor LTE exposure exceeds the LTE threshold. The method 30 may further include highlighting intersection 55, 59 of the LTE threshold 51 and the conductor LTE exposure 50, 57 on the three-dimensional visualisation. Furthermore, as can be seen in FIG. 8, the method 30 may also include graphically representing, using the graphical display 14, a heatmap 60 of the conductor LTE exposure including the highlighted intersections 59 of the LTE threshold which graphically illustrates a depth of damage caused along the feeder by the excessive conductor LTE exposure over time.

The method 30 further includes calculating 45, using the processor 13, a volume under the three-dimensional visualisation of the conductor LTE exposure. The volume is calculated by taking a product of line distance (in metres), fault time (in seconds) and LTE exposure (MA² s). The volume is calculated based upon time and distance step sizes used in the simulation. The calculated volume aids in quantifying conductor LTE exposure into a single figure. The method 30 may be iterative or recursive. Accordingly, the method 30 may further include assessing 46 the effect of changes made to the circuit protection element parameters upon conductor LTE exposure, which may not necessarily be easily perceivable by the eye when looking at the three-dimensional visualisation, by referencing a prior or benchmark calculated volume figure and comparing it to a current calculated volume figure.

Accordingly, this process of making changes to the circuit protection element parameters and simulating a fault on the feeder may be iterative and have the aim of classifying the net effect of changes on the conductor LTE exposure as an increase, decrease or no effect. This aids in configuring the circuit protection element parameters applied in the power network.

The method 30 may therefore include suggesting 44, using the power network simulation module 17, potential changes to the simulated circuit protection parameters to prevent conductor LTE exposure from exceeding the LTE threshold. The method 30 may include deciding at block 47 whether or not to implement changes to the circuit protection element parameters.

A time step of 1 ms was used for all simulations after considering time taken by existing protection relays to cycle through its internal code. Some protection relays take 3 ms to cycle through its internal code. Circuit breaker operating time can be in the region of 50 to 100 ms. The 1 ms time step is well below the relay time and the resulting file size with data points is acceptable for processing. The same concept is used to determine an increment or step size for line or feeder distance or fault position. If the step size is too coarse data will be lost and if it is too fine a number of resultant data points and execution time becomes impracticable. A distance step size of a 100 evaluation points per line was applied. For a distribution feeder, the line distance can be anything from a couple of meters to a 100 km's, the latter being uncommon. If a distance of 15 km is used the distance step size will be 150 m and if the distance was 50 km it will result in a step size of 500 m. All of this will produce acceptable results when considering how the fault levels will change across the feeder distance.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and/or computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create modules for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process (or method), such that the instructions which execute on the computer, other programmable apparatus, or other device implement the functions/acts specified in the flowchart and/or block diagram block or blocks. The flowchart and/or block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The Applicant believes that the system 10, method 30 and computer program product in accordance with the invention provide an effective way of simulating and thus evaluating circuit protection of the power network 40 to establish whether or not circuit protection elements of the power network and their associated parameters are adequate or suitable to prevent or limit instances where conductor LTE exposure 50, 57 exceeds the LTE threshold 51 of a particular conductor or feeder to prevent damage to the feeder. The Applicant believes that the three-dimensional visualisation of conductor LTE exposure 50, 57 and LTE threshold 51 of the feeder allows a user intuitively to assess or evaluate the adequacy of the circuit protection of the power network 40. This is especially advantageous for multisource, interconnected power networks where fault current on an interconnected feeder may dynamically fluctuate depending on operating times of the respective circuit protection elements. Also, by way of iteration and calculation of the volume under the three-dimensional visualisation of the conductor LTE exposure, the effect of parameter changes can be easily assessed and interpreted.

Through use of the method 30 and system 10 in accordance with the invention, it is possible to evaluate conductor let-through energy exposure of conductors in a multi-source interconnected network. To evaluate the conductor's let-through energy exposure 50, 57, the interconnected network 40 has to be considered wholistically due to the fact that circuit breaker operation in the multi-source interconnected network will result in fault current redistribution over time. This change in fault current changes the protection operating time. The change in fault current and exposure time creates different let-through energy levels over time at different positions on the faulted feeder.

The ability to graphically represent a two-dimensional heat map of let-through energy over distance vs. time including highlighted intersection of the LTE threshold allows one to intuitively deduce a depth of conductor damage. The time component allows other circuit breakers in the network to operate and the fault current to redistribute. The change in conductor let-through energy exposure is captured in the current that is measured at either end of the feeder and the relay operating time (time to trip). Some of the protection elements that can be evaluated are high-set elements, deadtime, auto-reclosing and different operating curves. The Applicants believe that the method 30 provides an effective method for evaluating the conductor exposure in both radial and multi-source interconnected networks. This wholistic evaluation method assists with identifying elements that influence let-through energy and supports optimising protection settings with the aim of minimising conductor let-through energy exposure.

The solution provided by the method 30 is the graphical illustration of the three-dimensional conductor LTE exposure. This allows the feeder to be evaluated not only from a LTE to distance perspective, but with additional insight into the effect of fault time. The time component allows for more insight into to be gained into the dynamic behaviour of the conductor LTE exposure. Looking at the graphs one can see which auto-reclose attempts violate the LTE threshold (a flat surface in three dimensions) and at what point in time this occurs. In a merely two-dimensional representation, all this dynamic information is lost and only a peak can be seen. The method provides a clear “Yes” or “No” answer to the question of whether the conductor is protected, but it is very limited in determining what caused the exceedance. If the conductor LTE exposure is viewed as a contour or heat map, intersection of the LTE threshold and conductor LTE exposure highlight boundaries of areas where the conductor limit or threshold is exceeded. This is achieved by subtracting the conductor LTE exposure from the LTE threshold (planar surface).

The three-dimensional representation of results with LTE-distance-time provides good insight into what protection elements may be responsible for causing the exceedance, where it is occurring on the feeder and from what point in time. This information may be used to adjust applied protection settings to prevent the exceedance. The contour or heat map complements the three-dimensional visualisations. Furthermore, volume quantification works well for quantifying the conductor LTE exposure into a number that can be compared to other simulations for the purpose of classifying the change as a decrease or increase in exposure. The full evaluation method can be applied to both radial and interconnected multi-source networks. When evaluating an interconnected multi-source feeder, the LTE contribution from both ends of the conductor has to be considered and it has to be considered at every point in distance and time on the feeder. These contributions cannot be evaluated individually. The complete network has to be considered together with the contribution from each end at the same time.

1. A computer-implemented method of evaluating circuit protection of a power network, the method including:
simulating, using a power network simulation module, the power network which includes at least one power source, at least one conductor or feeder connected to the power source and associated circuit protection;
simulating, using the power network simulation module, at least one fault on the power network at a predetermined fault position on the conductor or feeder for a predefined simulation time;
calculating, using a processor, conductor Let-Through Energy (LTE) exposure, due to the simulated fault, across a predetermined length of the conductor for the predefined simulation time; and
graphically representing, using a graphical display of a computing device, a three-dimensional visualisation of the conductor LTE exposure across the predetermined length of the conductor for the predefined simulation time.

2. The method as claimed in claim 1, wherein the three-dimensional visualisation has three axes, a first axis of the three-dimensional visualisation representing line distance or position (in metres) along the predetermined length of the conductor, a second axis of the three-dimensional visualisation representing elapsed fault time (in seconds) and a third axis representing LTE energy (MA² s).

3. The method as claimed in claim 1, wherein simulating the power network includes determining an LTE threshold or limit for the conductor or feeder of the power network and wherein graphically representing the three-dimensional visualisation of the conductor LTE exposure includes simultaneously graphically representing the LTE threshold for the conductor and the conductor LTE exposure on the same three-dimensional visualisation.

4. The method as claimed in claim 3, which includes highlighting intersection of the LTE threshold and the conductor LTE exposure on the three-dimensional visualisation.

5. The method as claimed in claim 4, which includes graphically representing, using the graphical display, a heatmap of the conductor LTE exposure including the highlighted intersection of the LTE threshold and the conductor LTE exposure which graphically illustrates a depth of damage caused along the conductor by excessive conductor LTE exposure over time.

6. The method as claimed in claim 3, which includes superimposing, in three dimensions, using the graphical display, the simulated conductor LTE exposure over the LTE threshold for the conductor in the three-dimensional visualisation.

7. The method as claimed in claim 3, which includes identifying, using the computing device, areas along the conductor where conductor LTE exposure exceeds the LTE threshold, if any, and calculating, using the processor, a threshold-exceeding fault time which is the fault time at which the conductor LTE exposure exceeds the LTE threshold at any given point along the conductor.

8. The method as claimed in claim 3, which includes:
simulating, using the power network simulation module, multiple circuit protection elements at different positions of the power network;
setting circuit protection parameters for each circuit protection element based upon a specific protection philosophy;
grading the network so as to obtain selectivity and ensuring that the circuit protection elements are sensitive to faults; and
suggesting, using the power network simulation module, potential changes to the circuit protection parameters to prevent the conductor LTE exposure from exceeding the LTE threshold.

9. The method as claimed in claim 3, which includes simulating, using the power network simulation module, a multi-source, interconnected power network.

10. The method as claimed in claim 9, wherein calculating conductor LTE exposure includes generating, using a data generation module, fault current values of the power network based upon the circuit protection of the power network for the predefined simulation time and at each position along the predetermined length of the conductor.

11. The method as claimed in claim 10, which includes:
generating, using the data generation module, a matrix of discrete incremental data points for the predetermined length of the conductor and the predefined simulation time; and
calculating, using the processor, conductor LTE exposure for each data point of the matrix.

12. The method as claimed in claim 1, which includes calculating, using the processor, a volume under the three-dimensional visualisation of the conductor LTE exposure, the volume being calculated by taking a product of line distance (in metres), fault time (in seconds) and LTE exposure (MA² s), the calculated volume aiding in quantifying conductor LTE exposure into a single figure, wherein this calculated volume figure is used to assess the effect of changes made to circuit protection parameters upon conductor LTE exposure with the aim of classifying the net effect on the conductor LTE exposure as an increase, decrease or no effect thus aiding in configuring the circuit protection parameters applied in the power network.

13. A system for evaluating circuit protection of a power network, the system including at least one computing device having a processor and a power network simulation module, wherein the system is configured to:
simulate, using the power network simulation module, the power network which includes at least one power source, at least one conductor or feeder connected to the power source and associated circuit protection;
simulate, using the power network simulation module, at least one fault on the power network at a predetermined fault position on the conductor or feeder for a predefined simulation time;
calculate, using the processor, conductor Let-Through Energy (LTE) exposure, due to the simulated fault, across a predetermined length of the conductor for the predefined simulation time; and
graphically represent, using a graphical display of the computing device, a three-dimensional visualisation of the conductor LTE exposure across the predetermined length of the conductor for the predefined simulation time.

14. The system as claimed in claim 13, which is configured to perform the method steps as claimed in claim 1.

15. A non-transitory computer-readable storage medium, having program instructions stored thereon, which, when executed by a processor of a computing system, enable the computing system to perform the method steps as claimed in claim 1.
